(19) United States
(12) Patent Application Publication
(10) Pub. No.: US 2024/0286379 A1
(43) Pub. Date: Aug. 29, 2024

(54) COMPOSITE GEOSYNTHETIC FABRIC WITH INCREASED PEEL STRENGTH

(71) Applicant: Groupe Solmax, Inc., Varennes (CA)

(72) Inventors: Gregory Rader, Ringgold, GA (US); David Michael Jones, Buford, GA (US); Kevin Nelson King, Mount Airy, GA (US)

(73) Assignee: Groupe Solmax, Inc., Varennes (CA)

(21) Appl. No.: 18/585,147

(22) Filed: Feb. 23, 2024

Related U.S. Application Data
(60) Provisional application No. 63/486,758, filed on Feb. 24, 2023.

(51) Int. Cl. B32B 5/26; B32B 5/02; B32B 5/06; B32B 37/16; D03D 9/00; D03D 15/46; D04H 1/00; D04H 18/02

(52) U.S. Cl. CPC B32B 5/275; B32B 5/022; B32B 5/024; B32B 5/028; B32B 5/06; B32B 37/16; D03D 9/00; D03D 15/46; D04H 1/00; D04H 18/02; B32B 2250/20; B32B 2262/16; B32B 2305/188; B32B 2305/28; B32B 2307/54; B32B 2307/554; B32B 2307/558; B32B 2307/71; B32B 2307/718; B32B 2307/726; B32B 2307/748; D10B 2505/18

(57) ABSTRACT

A composite geosynthetic fabric includes a woven fabric and a nonwoven fabric adhered to the woven fabric. The nonwoven fabric includes a plurality of fibers, with each fiber of the plurality of fibers of the nonwoven fabric being about 2 to about 18 denier per filament. A portion of the fibers of the nonwoven fabric extend through the woven fabric and is fused together on a face of the woven fabric that is opposite a nonwoven face side of the woven fabric.

### CROSS-REFERENCE TO RELATED APPLICATION

This application claims the benefit of U.S. Provisional Patent Application No. 63/486,758, filed Feb. 24, 2023, which is incorporated by reference herein in its entirety.

### BACKGROUND

The present disclosure relates to geosynthetic fabrics, and more particularly, to composite geosynthetic fabrics with increased peel strengths.

Composite geosynthetics include two or more fabrics (one or more of each of a woven and/or a nonwoven) that are adhered to one another. Composite geosynthetic fabrics are manufactured using specially engineered fabrics and fibers to provide excellent robustness, abrasion resistance, ultraviolet protection, and impact resistance in hydraulic and marine environments, among others. Such systems also entrap sand and other sediment to enhance durability for extended lifetimes.

### SUMMARY

According to one or more embodiments, a composite geosynthetic fabric includes a woven fabric and a nonwoven fabric adhered to the woven fabric. The nonwoven fabric includes a plurality of fibers, with each fiber of the plurality of fibers of the nonwoven fabric being about 2 to about 18 denier per filament. A portion of the fibers of the nonwoven fabric extend through the woven fabric and is fused together on a face of the woven fabric that is opposite a nonwoven face side of the woven fabric.

According to other embodiments, a method of making a composite geosynthetic fabric includes providing a preformed nonwoven fabric with a plurality of fibers, each being about 2 to about 18 denier per filament. The method also includes adhering a woven fabric to the pre-formed nonwoven fabric by pushing a portion of the plurality of fibers of the nonwoven fabric through the woven fabric such that the portion of the plurality of fibers extends from a face of the woven fabric that is opposite the nonwoven fabric. The method further includes fusing the portion of the plurality of fibers that extend from the face of the woven fabric.

Additional features and advantages are realized through the techniques of the present invention. Other embodiments and aspects of the invention are described in detail herein and are considered a part of the claimed invention. For a better understanding of the invention with the advantages and the features, refer to the description and to the drawings.

### BRIEF DESCRIPTION OF THE SEVERAL VIEWS OF THE DRAWINGS

For a more complete understanding of this disclosure, reference is now made to the following brief description, taken in connection with the accompanying drawings and detailed description, wherein like reference numerals represent like parts:

FIG. 1A is a schematic diagram showing a partial cross-section of a composite geosynthetic fabric;

FIG. 1B is a schematic diagram showing a partial cross-section of the composite geosynthetic fabric with fused knots; and

FIG. 2 is flow diagram illustrating a method of making a composite geosynthetic fabric;

FIG. 3A shows a needle board used to needle punch a preformed nonwoven to a woven;

FIG. 3B shows a single-barb needle and a six-barb needle;

FIG. 4 shows a comparative non-preformed nonwoven composite abraded after 500 cycles (top) and a composite as described herein abraded after 5,000 cycles (below).

FIG. 5 shows a composite as described herein abraded after 1,500 cycles (left) and a comparative non-preformed nonwoven composite abraded after 500 cycles (right); and

FIG. 6 shows a composite fabric (99A) as described herein after impact testing.

### DETAILED DESCRIPTION

Composite geosynthetic fabrics must provide excellent robustness, abrasion resistance, ultraviolet (UV) protection, and impact resistance in hydraulic and marine environments, among other harsh environments. In order to provide such properties, the fibers and fabrics are carefully selected. When the composite fabric includes a nonwoven, generally, using larger fibers results in a thicker composite with better abrasion resistance, improved UV protection, and increased water flow. When the composite fabric is formed by needle punching the fibers of a nonwoven fabric through a woven fabric, generally the woven fabric should be formed from yarns that are thin enough to punch through. In particular, woven fabrics with non-fibrillated tape yarns are preferred because they are thin, e.g., typically 1.5 mils to 2.5 mils thick, and therefore are easy to penetrate by needle punching.

In contrast, fibrillated tape yarns are less desirable to needle punch because they are thicker due to being cut during extrusion to provide a pattern that allows the tape yarns to be folded and compacted to make their respective cross sections smaller. Such processing of fibrillated tape yarns is necessary to weave them in the weft direction because the projectile must be able to fit the yarn into its gripper and pull the yarn across the loom.

Monofilament yarns in a woven are generally too thick and difficult to punch through, with typical thicknesses of at least 8 mils, and are therefore not used in mechanically bonded needle punch composites. Woven fabrics with monofilament yarns can and do cause needle damage when making needled composites.

Further, generally using more fabric layers in the composite means higher abrasion resistance, impact resistance, and long-term durability in a variety of harsh environments. Such environments include those along shorelines where ice dams can surge and create large energy impacts against the composite, along with tree limbs, wave action, boats, and propellers.

With the foregoing general limitations, composite geosynthetic fabrics generally are manufactured with large fiber nonwovens and wovens made with fibrillated and/or non-fibrillated tapes, and with more than two layers. Drawbacks of such resulting composites are that they are heavy and expensive to manufacture, despite being strong and resistant to abrasion and UV degradation.

One or more embodiments of the invention described herein address the foregoing drawbacks by providing composite geosynthetics, and methods of making and using thereof, that include a woven fabric and a pre-formed nonwoven fabric adhered to the woven fabric, in which the nonwoven fabric has a plurality of small fibers of about 2 to about 18 denier per filament, and wherein a portion of the fibers of the nonwoven fabric extends through the woven fabric and is fused together on a face of the woven fabric that is opposite the nonwoven face side of the woven fabric. Unexpectedly, using significantly smaller fibers in the pre-formed nonwoven provides higher surface area coverage than larger fibers, and results in a composite with the same or better abrasion resistance, impact resistance, UV resistance, and peel strength adhesion, and higher water flow than a nonwoven with larger fibers, and with a lighter composite weight.

In embodiments, the composite geosynthetic fabric includes only or consists of one layer of the woven fabric and only one layer of the nonwoven fabric in a two layer composite. The two layer composite is unexpectedly and advantageously lighter and less expensive to manufacture than composites with more than two layers, and unexpectedly, has the same, similar, or better abrasion and impact resistance, peel strength, UV resistance and water flow of three layer composites.

In other embodiments, the nonwoven fabric is a pre-formed stand-alone nonwoven fabric. In some embodiments, the composite geosynthetic fabric is made by needle-punching a portion of the plurality of fibers of the pre-formed nonwoven fabric through the woven fabric such that the portion of the plurality of fibers extend from a face of the woven fabric that is opposite the nonwoven fabric. In one or more embodiments, the woven fabric is formed from monofilament yarns and fibrillated tape yarns. In embodiments, the method further includes fusing a portion of the plurality of fibers that extend from the face of the woven fabric by applying open flame heat or heat to the backside of the protruding needle-punched fibers to melt and singe them to form melted knots or singed fibers.

Composites formed from loose, carded webs (non-pre-formed nonwovens) and wovens with tape yarns are expected to form desirable geosynthetics for several reasons. One of ordinary skill in the art would expect nonwoven fibers would more easily needle-punch through a woven fabric with only thin fibrillated and/or non-fibrillated tape yarns because monofilament yarns are too thick and tend to damage and break as the penetrate through the woven backing. Additionally, stand-alone pre-formed nonwovens have fibers that are already mechanically bonded, which would be expected to increase difficulty of punching through. Because is desirable for fibers of the nonwoven to penetrate from the nonwoven to the underside of the woven backing, locking in the two layers, the looser the fibers, the more readily they tend to be punched and transferred through to the backside of the reinforcement woven backing. Generally, only woven fabrics with fibrillated tape and/or non-fibrillated tape yarn can be needle-punched through to avoid excessive tensile loss. However, unexpectedly, as described herein, the woven fabric with monofilaments, in addition to fibrillated tape yarns, could be needle-punched through to adhere the smaller denier fibers in the pre-formed nonwoven to the woven fabric.

Typical geosynthetic needles have multiple barbs that are required to secure large amounts of fiber and to transfer a portion of the fibers from the top side to the underside of the reinforcement backing. In order to needle punch the nonwoven fibers through the monofilaments in the woven fabric, a portion of the needles from the needle board machine is removed to decrease the density of the needles in a particular pattern. Additionally, reducing the needle density and number of barbs per needle generates less tensile loss of the backing. This reduction in tensile loss is a result from monofilament yarns not tearing from the needles and allows the backing to be lighter weight. This decrease in tensile loss also allows a lower initial pre-needled tensile strength backing, since the resultant composite has maintained a higher percentage of its initial strength. As a result, substantially enough nonwoven fibers are needle punched through the woven fabric to leave a sufficient number extending from the opposing side of the woven fabric for enhanced peel strength.

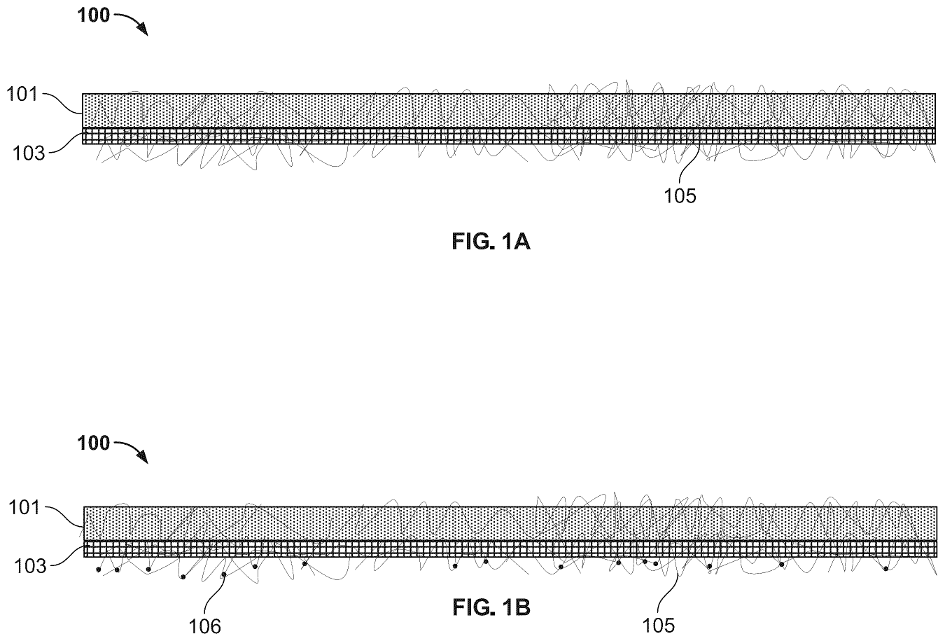

Further, one of ordinary skill in the art would conventionally expect larger fibers to provide more adhesion and abrasion resistance. However, as described herein, the smaller denier fibers of the nonwoven are pushed through the woven backing in greater number, creating a higher total surface area that when lightly singed, forms ‘melted knots’ on the back side of the woven (see FIG. 1B). The population of melted knots create the increased peel strength and greater adhesion between the woven and nonwoven in the composite. The higher fiber-to-fiber cohesion with smaller denier fibers also contributes to this unexpected result.

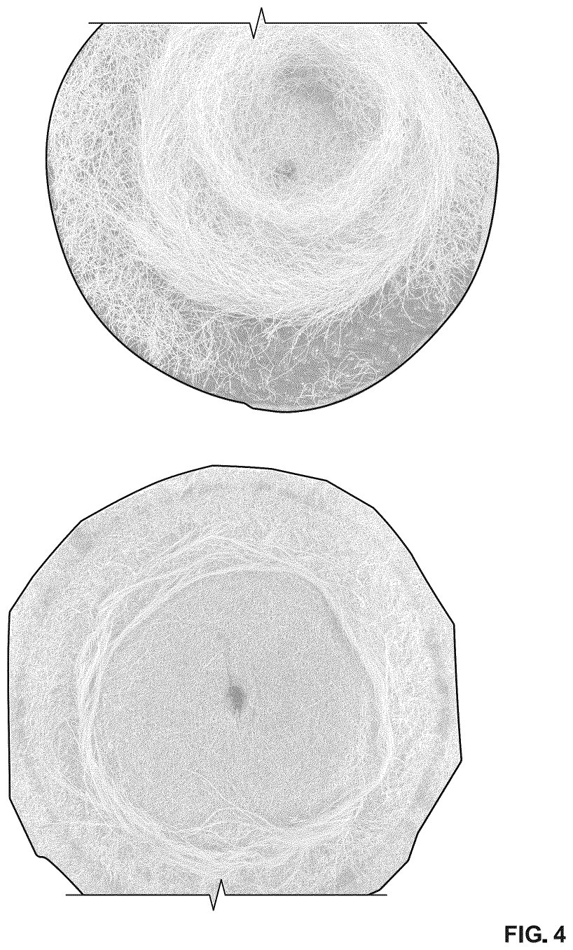

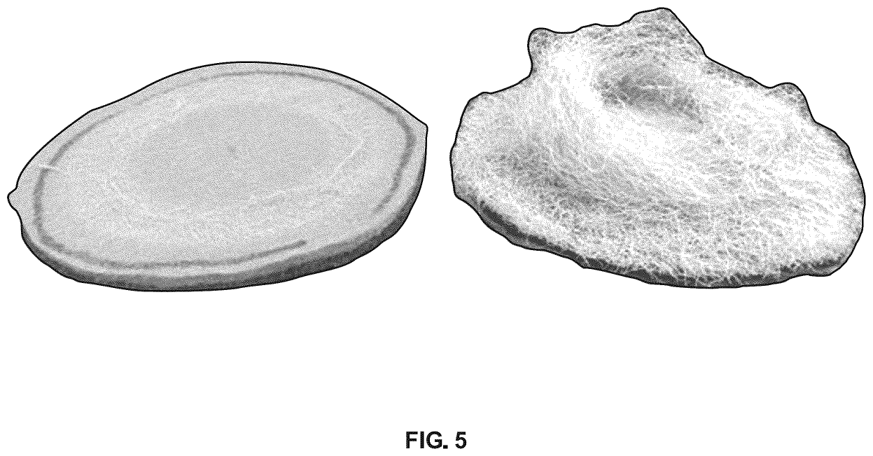

Although larger fibers in the nonwoven would be expected to resist abrasion, FIG. 4 demonstrate that the opposite is observed. FIG. 4 compares abrasion resistance of composites formed as described herein with pre-formed nonwovens (bottom), and comparative composites with carded nonwovens with larger fibers (top). Abrasion resistance is measured according to ASTM 3884 test method. As shown, the carded loose webs (top) had less mechanical fiber-to-fiber entanglement and less abrasion resistance after 500 cycles of abrasion compared to the preformed nonwoven composites (bottom) after 5,000 cycles of abrasion, which is due to the lack of fiber-to-fiber cohesion, low fiber compaction due to the bulkier fiber size, and lower bond strength to the woven. FIG. 5 similarly shows a composite (face side showing, with the woven backing below) as described herein abraded after 1,500 cycles (left) and a comparative non-preformed nonwoven composite abraded after 500 cycles (right).

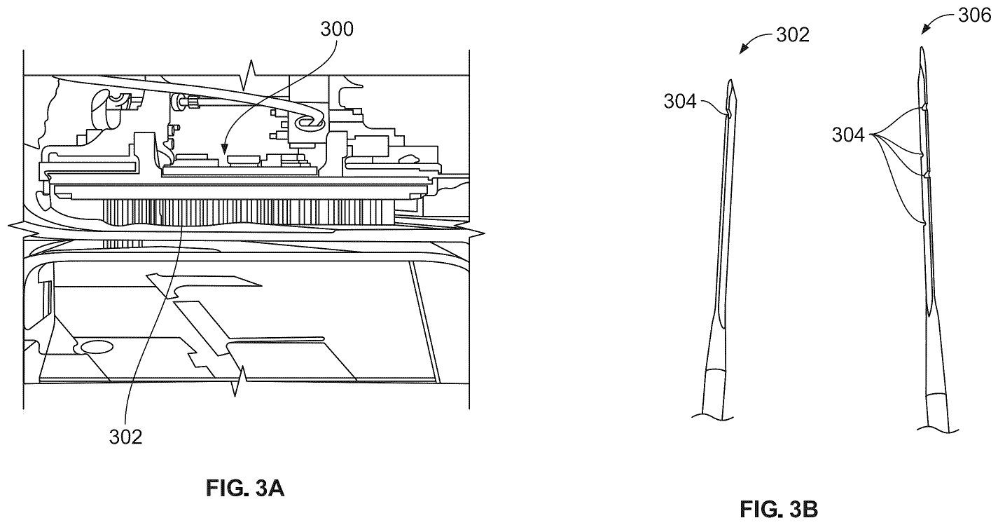

The density of the needles 302 in the needle board 300 (FIG. 3A) is modified and less than a conventional needle punchboard used to punch a loose, non-preformed nonwovens. The needles 302 themselves are also modified compared to conventional needles and include a single-barb 304 rather than a plurality of barbs, such as 6-barbs 304 (FIG. 3B). In some embodiments, the density of the needles in the needle punchboard is about 50 to about 100 needles (or punches) per square inch (ppsi). In other embodiments, the density of the needles in the needle punchboard is about 75 to about 95. In embodiments, the density of the needles in the needle punchboard is about or in any range between about 50, 55, 60, 65, 70, 75, 80, 85, 90, and 100 needles per square inch or ppsi. In one or more embodiments, the needle board has a plurality of single-barb needles.

Furthermore, one of ordinary skill in the art would expect that by reducing the number of punches or needles per square inch would result in lower peel strength because fewer fibers would be pushed through the backside of the reinforcing woven backing. However, unexpectedly, the smaller denier fibers generate greater peel strength when needled with fewer punches per square inch (ppsi) than with a higher number of ppsi and with larger fibers. Such result is partly due to the increased surface area of the total number of smaller fibers and the increased fiber-to-fiber cohesion that results with significantly smaller dpf fibers (e.g., 2-18 dpf fibers compared to greater than 100 dpf fibers).

Further, the nonwoven fabric is a pre-formed fabric, rather than a carded fiber web (non-pre-formed). Compared to a carded web, pre-formed nonwovens as described herein have tightly bound fibers that have been needle-punched and mechanically entangled to create a fully formed stand-alone nonwoven fabric. It is expected that it would be harder to punch mechanically bound fibers of a preformed nonwoven through a woven backing than looser fibers of a carded web for acceptable peel strength adhesion and water flow, but this was not the case.

By using the pre-formed nonwoven, the composite is formed in a single step process, in which the pre-formed nonwoven and woven are adhered together by needle punching. A preformed nonwoven has much lower water flow than a carded web, and is expected to result in a composite with lower water flow. However, the contrary is found. The composite with the pre-formed nonwoven had higher water flow than the composite with the carded web (see Table 8).

At least a portion of the fibers that is punched through and extend from the opposing side of the woven fabric is fused together by applying heat to the fibers. Lightly singing the fibers form melted knots that result in increased adhesion of the nonwoven to the woven fabric. A greater number of smaller knots formed from fusing smaller denier per filament (dpf) fibers provides greater peel strength adhesion over a fewer number of larger dpf fibers (see Table 7).

In one or more embodiments, a composite geosynthetic fabric includes a 20 ounce per square yard (osy) nonwoven with 8 denier per filament (dpf) fibers needled to a woven fabric and singed on the woven side for enhanced peel strength.

FIG. 1A illustrates a schematic of a side view of a composite geosynthetic fabric 100 according to one or more embodiments. The composite geosynthetic fabric 100 includes a woven fabric 103 and a nonwoven fabric 101 adhered to the woven fabric 103. The nonwoven fabric 101 includes a plurality of fibers 105. A portion of the fibers 105 of the nonwoven fabric 101 extend through the woven fabric 103 and is at least partially fused together on a face of the woven fabric 103 that is opposite a nonwoven fabric 101 face side of the woven fabric (fused fibers 106, FIG. 1B).

In one or more embodiments, the composite geosynthetic fabric is a bi-component composite fabric with only (consists of only) two fabrics or two fabric layers (a two-layer composite), the woven fabric 103 and the nonwoven fabric 101. Using two fabrics instead of three fabrics reduces manufacturing cost as well as total weight of the composite, and without compromising performance or inadvertently increasing thicknesses of some areas.

In embodiments, the nonwoven fabric 101 is a pre-formed stand-alone fabric. The nonwoven fabric 101 is formed by carding and needle punching before adhering the nonwoven to the woven to form the composite in embodiments.

In embodiments, the nonwoven fabric 101 has a basis weight of about 12 to about 32 ounces per square yard (osy). In other embodiments, the nonwoven fabric 101 has a basis weight of about 15 to about 25 ounces per square yard. Yet in other embodiments, the nonwoven fabric 101 has a basis weight of about 18 to about 22 ounces per square yard. In embodiments, the nonwoven fabric 101 has a basis weight about or in any range between about 12, 13, 14, 15, 16, 17, 18, 19, 20, 21, 22, 23, 24, and 25 ounces per yard.

In one or more embodiments, each fiber 105 of the plurality of fibers of the nonwoven fabric 101 is about 2 to about 18 denier per filament (dpf). In other embodiments, each fiber 105 of the plurality of fibers of the nonwoven fabric 101 is about 5 to about 10 denier per filament. Still yet, in other embodiments, each fiber 105 of the plurality of fibers of the nonwoven fabric 101 is about 7 to about 9 denier per filament. In embodiments, each fiber 105 of the plurality of fibers of the nonwoven fabric 101 is about or in any range between about 2, 3, 4, 5, 6, 7, 8, 9, 10, 11, 12, 13, 14, 15, 16, 17, and 18 denier per filament.

Using a small denier per filament fiber 105 (about 2 to about 18 denier per filament) in the nonwoven fabric 101 unexpectedly provides the composite with higher ultraviolet, impact, water-flow, and abrasion resistance than larger fibers (e.g., 110 denier per filament). The result is unexpected because typically larger fibers provide larger composite weights and larger voids between the fibers, the primary drivers for higher water flow.

The woven fabric 103 includes monofilament yarns and fibrillated tape yarns. In embodiments, monofilament yarns are woven in the machine direction (MD), and fibrillated tape yarns are woven in the cross machine direction (XMD).

In one or more embodiments, the woven fabric is a twill with single or double pick insertion weave fabric. It is also critical to note that although a plain weave provides the greatest dimensional stability for any woven fabric, it has the largest number of interlacings. Therefore, when needle-punching composites using wovens with monofilaments, a plain weave is not desired because its interlacings are too tight. The optimal weave pattern for forming a composite is a loose weave with dimensional stability, such as a twill weave. A twill weave will have at least half the number of interlacings compared to a plain weave, depending on how many picks are in each shed, and create a structure where the yarns can slide around more easily, avoid being damaged, as well avoid damaging needles during the needle punching process. The foregoing advantages mitigate tensile loss in the resultant composite from yarn damage, as well as from needle damage. In contrast, composites that are needle punched with non-fibrillated tape warp and weft yarn woven backings (rather than with monofilaments as described herein) are preferred to have plain weaves because they are easier to penetrate and will not cause needle damage, as the yarns are thin and therefore easy to penetrate.

In some embodiments, the composite geosynthetic fabric 100 has a total basis weight of about 24 to about 40 ounces per square yard. In other embodiments, the composite geosynthetic fabric 100 has a total basis weight of about 27 to about 34 ounces per square yard. Still yet, in other embodiments, the composite geosynthetic fabric 100 has a basis weight of about or in any range between about 24, 25, 26, 27, 28, 29, 30, 31, 32, 33, 34, 35, 36, 37, 38, 39, and 40 ounces per square yard.

In one or more embodiments, after 1,000 hours of ultraviolet light exposure, the composite geosynthetic fabric 100 has ultraviolet retention of at least 90% as measured by ASTM D4355 test method. In other embodiments, after 1,000 hours of ultraviolet light exposure, the composite geosynthetic fabric 100 has ultraviolet retention of about 92% to about 97% as measured by ASTM D4355 test method. Still yet, in other embodiments, after 1,000 hours of ultraviolet light exposure, the composite geosynthetic fabric 100 has ultraviolet retention about or in any range between about 90%, 91%, 92%, 93%, 94%, 95%, 96%, 97%, 98%, and 99% as measured by ASTM D4355 test method.

In some embodiments, the composite geosynthetic fabric 100 has a biaxial (in the machine and cross-machine directions) adhesion strength of about 8 to about 12 pounds per inch as measured by ASTM 6496 peel adhesion test method. In other embodiments, the composite geosynthetic fabric 100 has a biaxial adhesion strength of about 9 to about 11 pounds per inch as measured by ASTM 6496 peel adhesion test method. Still yet, in some embodiments, the composite geosynthetic fabric 100 has a biaxial adhesion strength about or in any range between about 8, 9, 10, 11, and 12 pounds per inch as measured by ASTM 6496 peel adhesion test method.

In one or more embodiments, the composite geosynthetic fabric 100 has a biaxial wide width (WW) tensile strength of at least 300 pounds per inch (lbs/in) in both machine and cross machine directions as measured by ASTM D4595 test method. In some embodiments, the composite geosynthetic fabric 100 has a biaxial wide width tensile strength of about 300 lbs/in to about 550 lbs/in in both machine and cross machine directions as measured by ASTM D 595 test method. Still yet, in other embodiments, the composite geosynthetic fabric 100 has a biaxial wide width (WW) tensile strength about or in any range between about 300, 325, 350, 375, 400, 425, 450, 475, 500, 525, and 550 pounds per inch (lbs/in) in both machine and cross machine directions as measured by ASTM D4595 test method.

In embodiments, the composite geosynthetic fabric 100 has an abrasion resistance demonstrated by maintaining about 90% to about 95% tensile strength after 80,000 revolutions as measured by ISO 22182 test method. In other embodiments, the composite geosynthetic fabric 100 has an abrasion resistance demonstrated by maintaining about 91% to about 94% tensile strength after 80,000 revolutions as measured by ISO 22182 test method. Still yet, in other embodiments, the composite geosynthetic fabric 100 has an abrasion resistance demonstrated by maintaining about or in any range between about 90%, 91%, 92%, 93%, 94%, and 95% tensile strength after 80,000 revolutions as measured by ISO 22182 test method.

In one or more embodiments, the composite geosynthetic fabric 100 has an impact energy of at least 850 foot*pounds (ft*lbs), as measured by ASTM E1886 test method, which demonstrates the impact resistance. Sufficient impact resistance is essential in applications where the composite will be subject to impact by debris from boats, anchors, trees, etc. In other embodiments, the composite geosynthetic fabric 100 has an impact energy of about 850 to about 2,000 ft*lbs, as measured by ASTM E1886 test method. Still, in other embodiments, the composite geosynthetic fabric 100 has an impact energy of about 1,000 to about 1,500 ft*lbs, as measured by ASTM E1886 test method. In one or more embodiments, the composite geosynthetic fabric 100 has an impact energy of about or in any range between about 850, 900, 950, 1000, 1050, 1100, 1150, 1200, 1250, 1300, 1350, 1400, 1450, 1500, 1550, 1600, 1650, 1700, 1750, 1800, 1850, 1900, 1950, 2000 ft*lbs, as measured by ASTM E1886 test method.

In some embodiments, the composite geosynthetic fabric 100 has a water flow rate of about 10 to about 35 gallons per minute per square foot as measured by ASTM D4491 water flow test method. In other embodiments, the composite geosynthetic fabric 100 has a water flow rate of about 15 to about 25 gallons per minute per square foot as measured by ASTM D4491 water flow test method. Still, in one or more embodiments, the composite geosynthetic fabric 100 has a water flow rate of about or in any range between about 10, 15, 20, 25, 30, and 35 gallons per minute per square foot as measured by ASTM D4491 water flow test method.

The woven fabric of the composite includes monofilament yarns, which are needed for greater water flow than bi-directional (MD and XMD) tape yarn wovens, as well as higher ultraviolet and abrasion resistance that results from their greater thickness compared to thinner slit tape yarns. Additionally, the interstices from their greater warp crimp amplitude, which results from a thicker interlacing yarn in the machine direction (MD), provides higher water flow. As described above, while needle-punching through the woven with the monofilament yarns was not expected to be achievable to adhere the woven to the nonwoven, including the monofilaments is critical for maintaining the desired water flow and ultraviolet and abrasion resistance properties of the composite.

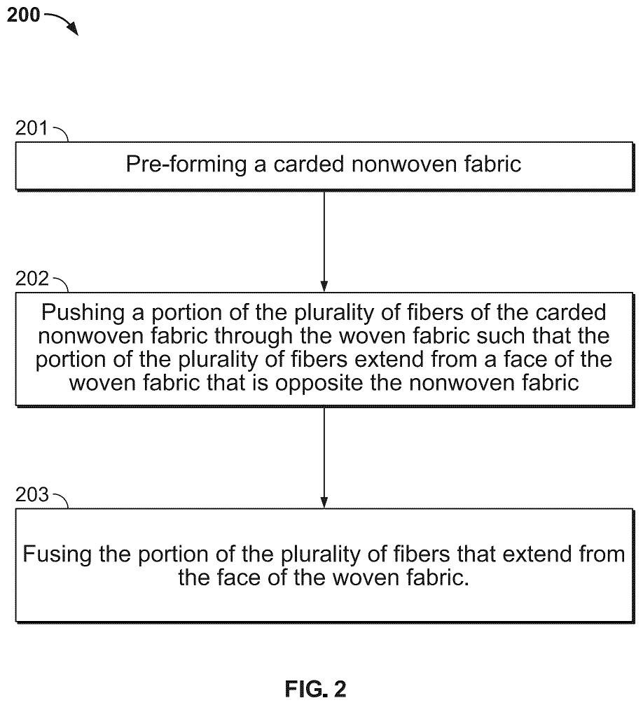

FIG. 2 is a flow chart illustrating a method 200 of making a composite fabric according to embodiments of the present invention. As shown in box 201, the method 200 includes pre-forming a carded nonwoven fabric. The nonwoven fabric is provided by pre-forming the nonwoven fabric before adhering it to the woven fabric to form the composite. The pre-formed nonwoven fabric includes a plurality of fibers, each being about 2 to about 18 denier per filament. In some embodiments, the nonwoven fabric is pre-formed by carding the plurality of fibers to form the nonwoven via needle punching, prior to adhering the nonwoven fabric to the woven fabric to form the composite.

As shown in box 202, the method 200 includes pushing a portion of the plurality of fibers of the nonwoven fabric through the woven fabric such that the portion of the plurality of fibers extend from a face of the woven fabric that is opposite the nonwoven fabric. In some embodiments, pushing the portion of the plurality of fibers of the nonwoven fabric through the woven fabric includes punching needles through the nonwoven fabric and the woven fabric, such as needle-punching. The fibers of the nonwoven fabric are pushed through to the opposing side of the woven fabric, leaving a portion of the fibers extending from the face of the woven fabric.

As shown in box 203, the method includes fusing (or singing) the portion of the plurality of fibers that extend from the face of the woven fabric (opposite the nonwoven). In order to improve adhesion of the nonwoven to the woven, heat, e.g., via a flame singer at high speed, is applied to the fibers to melt the loose fibers on the underside surface of the woven fabric. Fusing and melting the fibers significantly increases adhesion strength of the composite. Unexpectedly, the smaller denier fibers provide greater adhesion and peel strength over larger denier fibers. While an individual larger fiber has greater surface area than an individual smaller fiber, the higher number of fibers per unit area of smaller denier per filament fibers results in a much greater overall surface area and coverage of fibers that are pushed through to the back side of the woven, and once singed, forms more numerous melted knots. These fused knots generate much greater force to delaminate over larger denier per filament fibers that are fewer in number.

As used herein, the term “preformed nonwoven” and other like terms mean a fabric formed from a staple fiber carded web that is mechanically needle punched to bond the fibers together in a matrix and provide in a mechanically bonded, stand-alone fabric.

As used herein, the term “carded web” and other like terms mean a web of loose staple fibers arranged in a matrix where the fibers are stacked onto one another to produce a non-mechanically entangled batting.

### EXAMPLES

### Example 1: Composite Fabrics

Composite fabrics as described herein were constructed as shown in Tables 1 and 2.

TABLE 1

| | Sample ID | | | | | | | | | | | | | | | | | |
|---|---|---|---|---|---|---|---|---|---|---|---|---|---|---|---|---|---|---|
| | | | | | | | 000798B | | 000799B | | 000798A | | 000799A | | 000797A | | 000797B | |
| | 2027248757 | | 2027248758 | | 000799 | | (98B) | | (99B) | | (98A) | | (99A) | | (97A) | | (97B) | |
| Scrim, Woven | HP370 | | HP370 | | HP370 | | HP570 | | HP570 | | HP570 | | HP570 | | HP370 | | HP370 | |
| Fiber 1 | 110 | dpf | 8 | dpf | 110 | dpf | 110 | dpf | 8 | dpf | 110 | dpf | 8 | dpf | 110 | dpf | 110 | dpf |
| Fiber 1, % | 50 | | 100 | | 50 | | 50 | | 100 | | 50 | | 100 | | 50 | | 50 | |
| Fiber 2 | 8 | dpf | — | | 8 | dpf | 8 | dpf | — | | 8 | dpf | — | | 8 | dpf | 8 | dpf |
| Fiber 2, % | 50 | | — | | 50 | | 50 | | — | | 50 | | — | | 50 | | 50 | |
| Fiber Wt | 17 | osy | 17 | osy | 20 | osy | 20 | osy | 20 | osy | 20 | osy | 20 | osy | 17 | osy | 17 | osy |

| | | | | | | | | | |
|---|---|---|---|---|---|---|---|---|---|
| Carded Web | YES | YES | NO | NO | NO | NO | NO | NO | NO |
| Preformed NW | NO | NO | YES | YES | YES | YES | YES | YES | YES |
| Barbs | 6 | 6 | 1 | 1 | 1 | 1 | 1 | 1 | 1 |

TABLE 2
Composite fabric descriptions

| Sample ID | Description |
|---|---|
| Control | Woven tape × tape backing with 24 osy of 110 dpf fiber web carded and |
| (TC1200MB) | needle punched as a web into a 4 osy preformed NW into the woven |
| | backing using 6 barbed needles and IR heated on the underside |
| 2027248757 | Woven mono × fibrillated tape needled to a carded web 17 osy NW |
| | composed of 50% 8 dpf and 50% 110 dpf fiber blend needle punched |
| | with 6 barbed needle |
| 2027248758 | Woven mono × fibrillated tape woven with carded web 17 osy NW made |
| | of 100% 8 dpf and needle punched with 6 barbed needle |
| 000797A (97A) | Woven mono × fibrillated tape (HP370) woven with preformed 17 osy |
| | NW made of 50% 8 dpf and 50% 110 dpf fiber blend needle punched |
| | with single barbed needle with singeing |
| 000797B (97B) | Woven mono × fibrillated tape (HP370) needled with preformed 17 osy |
| | NW composed of 50% 8 dpf and 50% 110 dpf fiber blend needle |
| | punched with single barbed needle without singeing |
| 000798A (98A) | Woven mono × fibrillated tape (HP570) needled with preformed 20 osy |
| | NW composed of 50% 8 dpf and 50% 110 dpf fiber blend needle |
| | punched with single barbed needle with singeing |
| 000798B (98B) | Woven mono × fibrillated tape (HP570) needled with preformed 20 osy |
| | NW composed of 50% 8 dpf and 50% 110 dpf fiber blend fiber needle |
| | punched with single barbed needle without singeing |
| 000799A (99A) | Woven mono × fibrillated tape (HP570) needled with preformed 20 osy |
| | NW composed of 100% 8 dpf fiber needle punched with single barbed |
| | needle with singeing |
| 000799B (99B) | Woven mono × fibrillated tape (HP570) needled with preformed 20 osy |
| | NW composed of 100% 8 dpf fiber needle punched with single barbed |
| | needle with out singeing |
| 000799 | Woven mono × fibrillated tape (HP370) woven with preformed 20 osy |
| | NW made of 50% 8 dpf and 50% 110 dpf fiber blend needle punched |
| | with single barbed needle without singeing |
| GT1000MG | 25 osy woven fibrillated tape MD and fibrillated tape XMD. Biaxial |
| | 1000 lbs/in WW per ASTM D 4595 |

NW: nonwoven
dpf: denier per filament
osy: ounces per square yard
IR: infrared
PPSI: Punches per square inch

### Example 2: Impact Testing

Impact testing was conducted on various composites and compared to a control. Results are shown in Table 3 below and include the fabrics described in Tables 1 and 2 above. The control fabric was a three-layer composite of 20 ounces of loose, 110 denier per filament fiber needled through a 4 ounce per square yard preformed nonwoven and then through a woven with fibrillated tape yarns in both machine and cross-machine directions. The preformed 4 osy fabric was arranged between the carded web and backing and used to provide greater surface area to hold the fibers and thereby promote greater adhesion. The need for the 4 osy preformed fabric was eliminated when the smaller dpf fibers showed greater adhesion than expected, which reduced the overall composite weight, and as Table 3 shows, did not compromise tensile nor other properties desirable for shoreline protection.

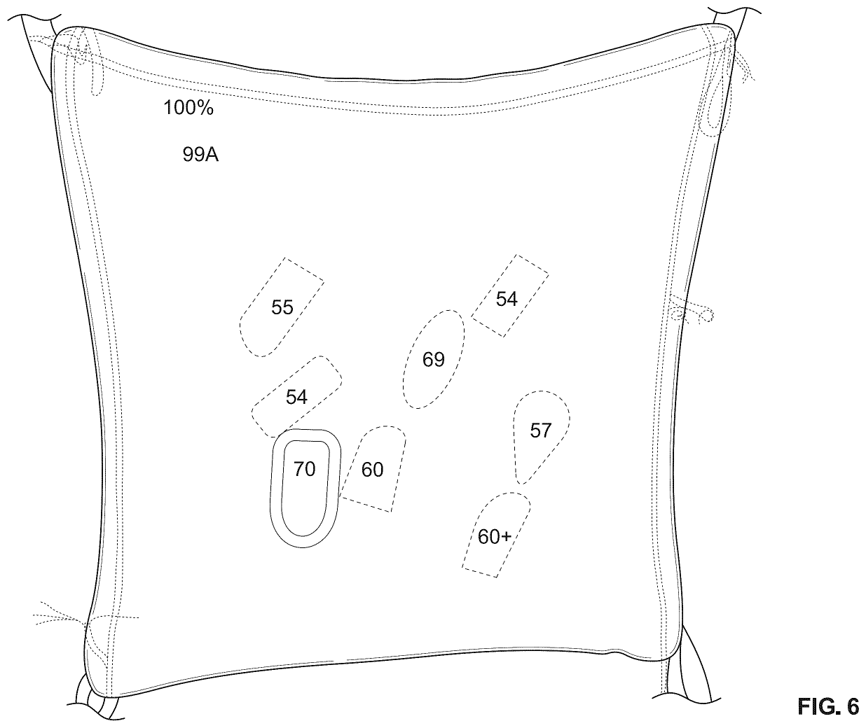

Impact testing was conducted according to ASTM E1886 test method. The estimated impact energy was measured in ft*lb, which equals mV²/g, using 1.46667 feet per second (ft/sec)=1 mile per hour (mph). The canon used had a 4-inch diameter barrel. In order to “pass,” the impact energy was greater than 850 ft*lbs without any sand loss. FIG. 6 shows a composite (99A) after impact testing.

TABLE 3
Impact testing results

| | | Missile Dimensions | | | | | Impact | bag | | Comments |
|---|---|---|---|---|---|---|---|---|---|---|
| Test | Impact | Weight | Length | Missile Velocity | | | Energy | weight | Pass/ | Failure |
| # | # | (lbs) | (in) | mph | ft/sec | kph | ft-lb | (lbs) | Fail | Type |
| 98B 50/50 | 1 | 9.4 | 85.5 | 59.0 | 86.53 | 95 | 1093.76 | 130.00 | P | ¾″ tear no |
| | | | | | | | | | | sand loss |
| 98B 50/50 | 2 | 9.4 | 85.5 | 70.0 | 102.67 | 113 | 1539.63 | | F | composite tear |
| | | | | | | | | | | and sand loss |
| 98B 50/50 | 3 | 9.4 | 85.5 | 68.0 | 99.73 | 109 | 1452.91 | | P | ¼″ tear no |
| | | | | | | | | | | sand loss |
| 98B 50/50 | 4 | 9.4 | 85.5 | 68.0 | 99.73 | 109 | 1452.91 | | F | composite tear |
| | | | | | | | | | | and sand loss |
| control | 1 | 9.4 | 85.5 | 60.0 | 88.00 | 97 | 1131.16 | 104.00 | P | impression |
| | | | | | | | | | | only |
| control | 2 | 9.4 | 85.5 | 65.0 | 95.33 | 105 | 1327.54 | | P | impression |
| | | | | | | | | | | only |
| control | 3 | 9.4 | 85.5 | 66.0 | 96.80 | 106 | 1368.70 | | P | ½″ tear no |
| | | | | | | | | | | sand loss |
| control | 4 | 9.4 | 85.5 | 71.0 | 104.13 | 114 | 1583.93 | | F | composite tear |
| | | | | | | | | | | and sand loss |
| control | 5 | 9.4 | 85.5 | 73.0 | 107.07 | 117 | 1674.42 | | F | composite tear |
| | | | | | | | | | | and sand loss |
| 99B 100% | 1 | 9.4 | 85.5 | 64.0 | 93.87 | 103 | 1287.00 | 139.00 | F | composite tear |
| 110 dpf | | | | | | | | | | and sand loss |
| 99B 100% | 2 | 9.4 | 85.5 | 65.0 | 95.33 | 105 | 1327.54 | | F | composite tear |
| 110 dpf | | | | | | | | | | and sand loss |
| 99B 100% | 3 | 9.4 | 85.5 | 66.0 | 96.80 | 106 | 1368.70 | | F | composite tear |
| 110 dpf | | | | | | | | | | and sand loss |
| 99B 100% | 4 | 9.4 | 85.5 | 58.0 | 85.07 | 93 | 1057.00 | | F | composite tear |
| 110 dpf | | | | | | | | | | and sand loss |
| 99B 100% | 5 | 9.4 | 85.5 | 61.0 | 89.47 | 98 | 1169.17 | | F | composite tear |
| 110 dpf | | | | | | | | | | and sand loss |
| 99A 100% | 1 | 9.4 | 85.5 | 72.0 | 105.60 | 116 | 1628.86 | 128.00 | F | composite tear |
| 110dpf | | | | | | | | | | and sand loss |
| 99A 100% | 2 | 9.4 | 85.5 | 71.0 | 104.13 | 114 | 1583.93 | | F | composite tear |
| 110dpf | | | | | | | | | | and sand loss |
| 99A 100% | 3 | 9.4 | 85.5 | 66.0 | 96.80 | 106 | 1368.70 | | F | composite tear |
| 110dpf | | | | | | | | | | and sand loss |
| 99A 100% | 4 | 9.4 | 85.5 | 55.0 | 80.67 | 89 | 950.48 | | P | impression |
| 110dpf | | | | | | | | | | only |
| 99A 100% | 5 | 9.4 | 85.5 | 66.0 | 96.80 | 106 | 1368.70 | | P | impression |
| 110dpf | | | | | | | | | | only |
| 98A 50/50 | 1 | 9.4 | 85.5 | 66.0 | 96.80 | 106 | 1368.70 | 144.00 | F | composite tear |
| | | | | | | | | | | and sand loss |
| 98A 50/50 | 2 | 9.4 | 85.5 | 67.0 | 98.27 | 108 | 1410.49 | | F | composite tear |
| | | | | | | | | | | and sand loss |
| 98A 50/50 | 3 | 9.4 | 85.5 | 66.0 | 96.80 | 106 | 1368.70 | | F | composite tear |
| | | | | | | | | | | and sand loss |
| 98A 50/50 | 4 | 9.4 | 85.5 | 64.0 | 93.87 | 103 | 1287.00 | | F | composite tear |
| | | | | | | | | | | and sand loss |
| 98A 50/50 | 1 | 9.4 | 85.5 | 49.0 | 71.87 | 79 | 754.42 | 107.00 | P | no impression |
| 98A 50/50 | 2 | 9.4 | 85.5 | 52.0 | 76.27 | 84 | 849.62 | | P | no impression |
| 98A 50/50 | 3 | 9.4 | 85.5 | 54.0 | 79.20 | 87 | 916.24 | | P | no impression |
| 98A 50/50 | 4 | 9.4 | 85.5 | 54.0 | 79.20 | 87 | 916.24 | | P | no impression |
| 98A 50/50 | 5 | 9.4 | 85.5 | 57.0 | 83.60 | 92 | 1020.87 | | P | no impression |
| 98A 50/50 | 6 | 9.4 | 85.5 | 60/62/64 | | | | | P | impression |
| | | | | | | | | | | only - 3 hits |
| | | | | | | | | | | same location |
| 99A 100% | 1 | 9.4 | 85.5 | 55.0 | 80.67 | 89 | 950.48 | 102.00 | P | no impression |
| 99A 100% | 2 | 9.4 | 85.5 | 54.0 | 79.20 | 87 | 916.24 | | P | no impression |
| 99A 100% | 3 | 9.4 | 85.5 | 54.0 | 79.20 | 87 | 916.24 | | P | no impression |
| 99A 100% | 4 | 9.4 | 85.5 | 57.0 | 83.60 | 92 | 1020.87 | | P | no impression |
| 99A 100% | 5 | 9.4 | 85.5 | 62.0 | 90.93 | 100 | 1207.82 | | P | no impression |
| 99A 100% | 6 | 9.4 | 85.5 | 60.0 | 88.00 | 97 | 1131.16 | | P | slight |
| | | | | | | | | | | impression |
| 99A 100% | 7 | 9.4 | 85.5 | 69.0 | 101.20 | 111 | 1495.95 | | P | ½″ tear no |
| | | | | | | | | | | sand loss |
| 99A 100% | 8 | 9.4 | 85.5 | 70.0 | 102.67 | 113 | 1539.63 | | F | 1½″ tear |
| | | | | | | | | | | sand loss |

### Example 3: Abrasion and Tensile Testing

Abrasion testing was conducted according to ISO 22182 test method. Wide width (WW) tensile measurements were conducted according to ISO 10319 test method. Testing was conducted on three fabrics. Fabric 98A, GT100 MG, and TC1200 MB (control) were tested (see Tables 1 and 2).

The inventive 99A fabric had an initial mean MD ultimate strength of 3005 lbs*force (Table 4). After being subjected to 80,000 revolutions of abrasion, the fabric had a mean MD ultimate tensile strength of 2811 lbs*force. The inventive fabric thus maintained about 93.5% MD ultimate tensile strength after 80,000 revolutions as measured by ISO 22182 test method.

TABLE 4
Abrasion testing on 99A

| | | | | | | | |
|---|---|---|---|---|---|---|---|
| Sample 99A | 1 | 2 | 3 | 4 | 5 | Mean | Std. Dev. |

BAW Abrasion Resistance (BAW-RPG/ISO 22182) - 80,000 revolutions
Wide Width Tensile (ISO10319) - As Received

| | | | | | | | |
|---|---|---|---|---|---|---|---|
| MD Specimen | 6.5 | | | | | | |
| Width (inches) | | | | | | | |
| MD Specimen | 165 | | | | | | |
| Width (mm) | | | | | | | |
| MD Ultimate | 2992 | 3058 | 3052 | 2971 | 2954 | 3005 | 47 |
| Strength (lbs) | | | | | | | |
| MD Ultimate | 13314 | 13608 | 13582 | 13222 | 13147 | 13374 | 210 |
| Strength (N) | | | | | | | |
| MD Ultimate | 460 | 470 | 470 | 457 | 455 | 462 | 7 |
| Strength (ppi) | | | | | | | |
| MD Ultimate | 80.6 | 82.4 | 82.3 | 80.1 | 79.6 | 81.0 | 1.3 |
| Strength (kN/m) | | | | | | | |
| MD Break | 10.3 | 10.9 | 10.5 | 10.5 | 10.2 | 10.5 | 0.3 |
| Elongation (%) | | | | | | | |

Wide Width Tensile (ISO10319) - After 80,000 Revolutions/Abrasion

| | | | | | | | |
|---|---|---|---|---|---|---|---|
| MD Specimen | 6.5 | | | | | | |
| Width (inches) | | | | | | | |
| MD Specimen | 165 | | | | | | |
| Width (mm) | | | | | | | |
| MD Ultimate | 2555 | 3042 | 2579 | 2933 | 2946 | 2811 | 227 |
| Strength (lbs) | | | | | | | |
| MD Ultimate | 11368 | 13536 | 11475 | 13051 | 13110 | 12508 | 1010 |
| Strength (N) | | | | | | | |
| MD Ultimate | 393 | 468 | 397 | 451 | 453 | 432 | 35 |
| Strength (ppi) | | | | | | | |
| MD Ultimate | 68.9 | 82.0 | 69.5 | 79.1 | 79.4 | 75.8 | 6.1 |
| Strength (kN/m) | | | | | | | |
| MD Break | 10.4 | 11.0 | 10.3 | 10.1 | 10.1 | 10.4 | 0.4 |
| Elongation (%) | | | | | | | |

*BAW: Body abrasive wear

The GT1000 MG fabric (Table 5) had an initial mean MD ultimate strength of 8,312 lbs*force. After being subjected to 80,000 revolutions of abrasion, the fabric had a mean MD ultimate tensile strength of 41.8 lbs*force. This fabric thus maintained 0.01% MD ultimate tensile strength after 80,000 revolutions as measured by ISO 22182 test method. The absence of the attached nonwoven in the stand-alone woven caused the significant loss after abrasion. Provided these results, in shoreline applications, a composite with a nonwoven facing the shoreline is critical to resist abrasion, and a woven backing is critical to provide the necessary tensile strength to withstand pumping forces while filling the composite Geotubes.

TABLE 5
Abrasion testing on GT1000MG

| | | | | | | |
|---|---|---|---|---|---|---|
| GT1000MG Woven | 1 | 2 | 3 | 4 | Mean | Std. Dev. |

BAW Abrasion Resistance (BAW-RPG/ISO 22182) - 80,000 revolutions
Wide Width Tensile (ISO10319) - As Received

| | | | | | | |
|---|---|---|---|---|---|---|
| MD Specimen Width (inches) | 6.5 | | | | | |
| MD Specimen Width (mm) | 165 | | | | | |
| MD Ultimate Strength (lbs) | 8434 | 8149 | 8302 | 8362 | 8312 | 121 |
| MD Ultimate Strength (N) | 37530 | 36261 | 36942 | 37213 | 36987 | 540 |
| MD Ultimate Strength (ppi) | 1298 | 1254 | 1277 | 1287 | 1279 | 19 |
| MD Ultimate Strength (kN/m) | 227 | 220 | 224 | 225 | 224 | 3 |
| MD Break Elongation (%) | 11.7 | 9.6 | 10.2 | 9.3 | 10.2 | 1.1 |

Wide Width Tensile (ISO10319) - After 80,000 Revolutions/Abrasion

| | | | | | | |
|---|---|---|---|---|---|---|
| MD Specimen Width (inches) | 6.5 | | | | | |
| MD Specimen Width (mm) | 165 | | | | | |
| MD Ultimate Strength (lbs) | 44.9 | 55.6 | 32.8 | 33.9 | 41.8 | 10.7 |
| MD Ultimate Strength (N) | 200 | 247 | 146 | 151 | 186 | 48 |
| MD Ultimate Strength (ppi) | 6.90 | 8.55 | 5.04 | 5.21 | 6.42 | 1.65 |
| MD Ultimate Strength (kN/m) | 1.21 | 1.50 | 0.88 | 0.91 | 1.13 | 0.29 |
| MD Break Elongation (%) | 9.27 | 10.2 | 2.70 | 3.81 | 6.51 | 3.80 |

The control TC1200 MB fabric (Table 6) had an initial mean MD ultimate strength of 3,214 lbs*force. After being subjected to 80,000 revolutions of abrasion, the fabric had a mean MD ultimate tensile strength of 3,369 lbs*force. This control fabric thus maintained 95.3% MD ultimate tensile strength after 80,000 revolutions as measured by ISO 22182 test method.

TABLE 6
Abrasion testing on TC1200MB (control)

| | | | | | | |
|---|---|---|---|---|---|---|
| TC1200MB sample | 1 | 2 | 3 | 4 | Mean | Std. Dev. |

BAW Abrasion Resistance (BAW-RPG/ISO 22182) - 80,000 revolutions
Wide Width Tensile (ISO10319) - As Received

| | | | | | | |
|---|---|---|---|---|---|---|
| MD Specimen Width (inches) | 6.5 | | | | | |
| MD Specimen Width (mm) | 165 | | | | | |
| MD Ultimate Strength (lbs) | 3156 | 3197 | 3198 | 3304 | 3214 | 64 |
| MD Ultimate Strength (N) | 14043 | 14225 | 14230 | 14705 | 14301 | 283 |
| MD Ultimate Strength (ppi) | 485 | 492 | 492 | 508 | 494 | 10 |
| MD Ultimate Strength (kN/m) | 85.1 | 86.2 | 86.2 | 89.1 | 86.6 | 1.7 |
| MD Break Elongation (%) | 6.5 | 7.0 | 7.7 | 8.8 | 7.5 | 1.0 |

Wide Width Tensile (ISO10319) - After 80,000 Revolutions/Abrasion

| | | | | | | |
|---|---|---|---|---|---|---|
| MD Specimen Width (inches) | 6.5 | | | | | |
| MD Specimen Width (mm) | 165 | | | | | |
| MD Ultimate Strength (lbs) | 3451 | 3111 | 3329 | 3585 | 3369 | 201 |
| MD Ultimate Strength (N) | 15356 | 13842 | 14816 | 15953 | 14992 | 896 |
| MD Ultimate Strength (ppi) | 531 | 479 | 512 | 552 | 518 | 31 |
| MD Ultimate Strength (kN/m) | 93.0 | 83.8 | 89.7 | 96.6 | 90.8 | 5.4 |
| MD Break Elongation (%) | 8.5 | 8.0 | 8.0 | 8.2 | 8.2 | 0.3 |

### Example 4: Tensile and Adhesion Loss

Tensile and adhesion loss of composites were tested. As shown in Tables 7-9, the pre-formed 4 ounce per square yard nonwoven in the control was not needed to provide the same tensile, adhesion, and/or water flow. Removing the 4 ounce per square yard preformed nonwoven resulted in a lighter fabric that provided an equivalent wide width (WW) tensile value and greater peel strength.

As also shown in Table 7, composites that were needle punched with a 6-barbed needle had significantly higher average % tensile loss (48%) after needling compared to composites formed with a single-barbed needle (16%). Needle punching with a single-barbed needle therefore could mitigate tensile loss, as well as using a woven backing with monofilament yarns in the machine direction because such thicker yarns are more resistant to tearing compared to a slit tape when needle punched. When monofilament yarns were used, the needles had a tendency to break during composite manufacturing because such thick needles did not allow sufficient space for needle passage. The monofilaments are round in contrast to tape yarns that are flat, which allowed the needles to deflect around the yarns, rather than punching through the yarns. Typical widths of monofilament yarns were 8 mils to 20 mils, whereas typical slit tape widths range from 45 mils to 100 mils. The single barbed needles still carried a sufficient amount of fibers through the woven to the underside for increased peel strength adhesion. Furthermore, by reducing the barbs, the needles did less damage to the woven backing, and in combination with using smaller dpf fibers in the preformed nonwoven, the single barbed needle still carried greater numbers of fibers through the woven backing for greater adhesion peel strength. The monofilament MD yarns provided additional void spaces to allow easier needle penetration and carried greater quantities of fibers through the woven backing to its underside.

TABLE 7
Tensile loss

| | | Preformed | Preformed |
|---|---|---|---|
| | Carded fiber 6 | NW 6 barbed | NW single |
| | barbed needle - | needle - 8 | barbed needle - |
| ASTM D4595 | 110 dpf fiber | dpf fiber | 8 dpf fiber |
| Avg tensile loss (%) | 48% | 45% | 16% |
| Needle density | 94 | 76 | 76 |
| (Punches/square inch) | | | |

Loose, carded webs were expected to be easier to punch and therefore use to form a composite with high adhesion strength. Further, larger fibers were expected to provide greater adhesion to a backing, but such large fibers did not perform as expected. Rather, the more difficult to punch, smaller fiber monofilaments with fibrillated tapes in the woven and a preformed nonwoven, with more void spacing and less fiber bind (i.e., ability of the backing to hold fibers that have been needle punched through the woven to its underside), had unexpectedly the best adhesion strength, as shown in Table 8. Singeing remained constant between samples.

Table 8 demonstrates that the preformed nonwoven with having entangled fibers that are more difficult to punch through provided higher peel adhesion strength, and with fewer punches per inch. Unexpectedly, a reinforcement backing with monofilament warp yarns and fibrillated tape weft yarns punched with smaller denier fibers in the nonwoven provided significantly higher peel strength adhesion, which was due to the fiber to fiber cohesion increase with smaller denier fibers and using a looser backing for greater volume of fibers to penetrate.

TABLE 8
Adhesion loss

| | | | Pre- | Pre- |
|---|---|---|---|---|
| | Fiber cap | Fiber cap | formed NW | formed NW |
| ASTM D6496 | singed | non singed | non singed | singed |
| Adhesion | 6.6 × 6.9 | 1.2 × 1.8 | 18.3 × 17.2 | 37.5 × 28.9 |
| (lbs*force) | | | | |
| (MD × XMD) | | | | |

Table 9 shows water flow of the inventive composites with the preformed nonwoven is higher than the control with the carded web nonwoven with looser fibers and inherently higher water flow. Higher dpf fibers had larger voids between the fibers and were bulkier, which resulted in higher flow rates through the material. As shown, the 99A fabric, with 100% small dpf fibers, had greater water flow than the control.

Higher dpf fibers from the control were approximately 10 times larger by weight, and were larger in diameter and bulk. Therefore, these larger fibers (i.e., >100 dpf), had greater voids between the fibers, resulting in higher flow rates through the material. The inventive fabric 99A, with 100% small dpf fibers, preferably between 2 dpf and 18 dpf, still had greater water flow in the resultant composite, as shown in Table 9 below.

TABLE 9
Water flow

| | Control | RLT- | RLT- | RLT- | RLT- |
|---|---|---|---|---|---|
| | TC1200MB | 00098A | 00099A | 00097A | 00097B |
| Waterflow, gpm | 12 | 23 | 16 | 28 | 29 |
| ASTM D4491 | | | | | |

Various embodiments of the present invention are described herein with reference to the related drawings. Alternative embodiments can be devised without departing from the scope of this invention. Although various connections and positional relationships (e.g., over, below, adjacent, etc.) are set forth between elements in the following description and in the drawings, persons skilled in the art will recognize that many of the positional relationships described herein are orientation-independent when the described functionality is maintained even though the orientation is changed. These connections and/or positional relationships, unless specified otherwise, can be direct or indirect, and the present invention is not intended to be limiting in this respect. Accordingly, a coupling of entities can refer to either a direct or an indirect coupling, and a positional relationship between entities can be a direct or indirect positional relationship. As an example of an indirect positional relationship, references in the present description to forming layer “A” over layer “B” include situations in which one or more intermediate layers (e.g., layer “C”) is between layer “A” and layer “B” as long as the relevant characteristics and functionalities of layer “A” and layer “B” are not substantially changed by the intermediate layer(s).

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “exemplary” is used herein to mean “serving as an example, instance or illustration.” Any embodiment or design described herein as “exemplary” is not necessarily to be construed as preferred or advantageous over other embodiments or designs. The terms “at least one” and “one or more” are understood to include any integer number greater than or equal to one, i.e. one, two, three, four, etc. The terms “a plurality” are understood to include any integer number greater than or equal to two, i.e. two, three, four, five, etc. The term “connection” can include an indirect “connection” and a direct “connection.”

References in the specification to “one embodiment,” “an embodiment,” “an example embodiment,” etc., indicate that the embodiment described can include a particular feature, structure, or characteristic, but every embodiment may or may not include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

For purposes of the description hereinafter, the terms “upper,” “lower,” “right,” “left,” “vertical,” “horizontal,” “top,” “bottom,” and derivatives thereof shall relate to the described structures and methods, as oriented in the drawing figures. The terms “overlying,” “atop,” “on top,” “positioned on” or “positioned atop” mean that a first element, such as a first structure, is present on a second element, such as a second structure, wherein intervening elements such as an interface structure can be present between the first element and the second element. The term “direct contact” means that a first element, such as a first structure, and a second element, such as a second structure, are connected without any intermediary conducting, insulating or semiconductor layers at the interface of the two elements.

The terms “about,” “substantially,” “approximately,” and variations thereof, are intended to include the degree of error associated with measurement of the particular quantity based upon the equipment available at the time of filing the application. For example, “about” can include a range of +8% or 5%, or 2% of a given value.

The flowchart and block diagrams in the Figures illustrate possible implementations of fabrication and/or operation methods according to various embodiments of the present invention. Various functions/operations of the method are represented in the flow diagram by blocks. In some alternative implementations, the functions noted in the blocks can occur out of the order noted in the Figures. For example, two blocks shown in succession can, in fact, be executed substantially concurrently, or the blocks can sometimes be executed in the reverse order, depending upon the functionality involved.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description but is not intended to be exhaustive or limited to the invention in the form disclosed. Many modifications and variations will be apparent to those of ordinary skill in the art without departing from the scope and spirit of the invention. The embodiments were chosen and described in order to best explain the principles of the invention and the practical application, and to enable others of ordinary skill in the art to understand the invention for various embodiments with various modifications as are suited to the particular use contemplated.

While the preferred embodiments to the invention have been described, it will be understood that those skilled in the art, both now and in the future, may make various improvements and enhancements which fall within the scope of the claims which follow. These claims should be construed to maintain the proper protection for the invention first described.

What is claimed is:

1. A composite geosynthetic fabric comprising:
a woven fabric; and
a nonwoven fabric adhered to the woven fabric, the nonwoven fabric comprising a plurality of fibers, each fiber of the plurality of fibers of the nonwoven fabric is about 2 to about 18 denier per filament;
wherein a portion of the plurality of fibers of the nonwoven fabric extend through the woven fabric and are fused together on a face of the woven fabric that is opposite a nonwoven face side of the woven fabric.

2. The composite geosynthetic fabric of claim 1, wherein the composite geosynthetic fabric is a bi-component composite fabric with only the woven fabric and the nonwoven fabric.

3. The composite geosynthetic fabric of claim 1, wherein the nonwoven fabric is a pre-formed stand-alone fabric.

4. The composite geosynthetic fabric of claim 1, wherein the nonwoven fabric has a basis weight of about 12 to about 32 ounces per square yard.

5. The composite geosynthetic fabric of claim 1, wherein the woven fabric has monofilament yarns and fibrillated tape yarns.

6. The composite geosynthetic fabric of claim 1, wherein the composite geosynthetic fabric has a basis weight of about 25 to about 40 ounces per square yard.

7. The composite geosynthetic fabric of claim 1, wherein after 1,000 hours of ultraviolet exposure, the composite geosynthetic fabric has an ultraviolet retention of at least 90% as measured by ASTM D 4355 test method.

8. The composite geosynthetic fabric of claim 1, wherein the composite geosynthetic fabric has a biaxial adhesion strength of about 20 pounds per inch to about 50 pounds per inch as measured by ASTM 6496 peel adhesion test method.

9. The composite geosynthetic fabric of claim 1, wherein the composite geosynthetic fabric has a biaxial wide width tensile strength of at least 300 pounds per inch in both machine and cross machine directions as measured by ASTM D 4595 test method.

10. The composite geosynthetic fabric of claim 1, wherein the composite geosynthetic fabric has an abrasion resistance demonstrated by maintaining about 90% to about 95% tensile strength after 80,000 revolutions as measured by ISO 22182 test method.

11. The composite geosynthetic fabric of claim 1, wherein the composite geosynthetic fabric has an impact energy of at least 850 feet*pounds, as measured by ASTM E 1886 test method.

12. A method of making a composite geosynthetic fabric, the method comprising:
providing a preformed nonwoven fabric comprising a plurality of fibers each being about 2 to about 18 denier per filament;
adhering a woven fabric to the preformed nonwoven fabric by pushing a portion of the plurality of fibers of the preformed nonwoven fabric through the woven fabric such that the portion of the plurality of fibers extend from a face of the woven fabric that is opposite the preformed nonwoven fabric; and
fusing the portion of the plurality of fibers that extend from the face of the woven fabric.

13. The method of claim 12, wherein the fusing include applying heat to fuse at least the portion of the plurality of fibers that extend from the face of the woven fabric.

14. The method of claim 12, wherein the adhering the woven fabric to the preformed nonwoven fabric includes needling the preformed nonwoven fabric through the woven fabric.

15. The method of claim 12, wherein needling the preformed nonwoven fabric through the woven fabric includes using a needle board with a needle density of about 55 to about 105 punctures per square inch (ppsi).

16. The method of claim 12, wherein needling the preformed nonwoven fabric through the woven fabric includes using a needle board with single-barb needles.

17. The method of claim 12, wherein providing the preformed nonwoven fabric comprises carding and needle punching the plurality of fibers.

18. The method of claim 12, wherein the woven fabric comprises monofilament yarns and tape yarns.

19. The method of claim 12, wherein pushing the portion of the plurality of fibers of the nonwoven fabric through the woven fabric includes punching needles through the nonwoven fabric and the woven fabric.

20. The method of claim 12, wherein the composite geosynthetic fabric is a bi-component composite fabric with only the woven fabric and the preformed nonwoven fabric.

21. The method of claim 12, wherein the preformed nonwoven fabric is a stand-alone fabric.

22. The method of claim 12, wherein the preformed nonwoven fabric has a basis weight of about 12 to about 32 ounces per square yard.

23. The method of claim 12, wherein the woven fabric has monofilament yarns and fibrillated tape yarns.

24. The method of claim 12, wherein the composite geosynthetic fabric has a basis weight of about 25 to about 40 ounces per square yard.

25. The method of claim 12, wherein after 1000 hours of ultraviolet exposure, the composite geosynthetic fabric has an ultraviolet retention of at least 90% as measured by ASTM D 4355 test method.

26. The method of claim 12, wherein the composite geosynthetic fabric has a biaxial adhesion strength of about 20 pounds per inch to about 50 pounds per inch as measured by ASTM 6496 peel adhesion test method.

27. The method of claim 12, wherein the composite geosynthetic fabric has a biaxial wide width tensile strength of at least 300 pounds per inch in both machine and cross machine directions as measured by ASTM D 4595 test method.

28. The method of claim 12, wherein the composite geosynthetic fabric has an abrasion resistance demonstrated by maintaining about 90% to about 95% tensile strength after 80,000 revolutions as measured by ISO 22182 test method.

29. The method of claim 12, wherein the composite geosynthetic fabric has an impact energy of at least 850 feet*pounds, as measured by ASTM E 1886 test method.
